(19) United States
(12) Patent Application Publication
(10) Pub. No.: US 2004/0176549 A1
(43) Pub. Date: Sep. 9, 2004

(54) Method for the production of cycloaliphatic compounds (1) having side chains with epoxy groups

(76) Inventors: Arnd Bottcher, Frankenthal (DE); Dominic Vanoppen, Kapellen (BE); Jan-Dirk Arndt, Mannheim (DE)

Correspondence Address: KEIL & WEINKAUF, 1350 CONNECTICUT AVENUE, N.W., WASHINGTON, DC, 20036, US

(21) Appl. No.: 10/480,239

(22) PCT Filed: Jun. 10, 2002
(86) PCT No.: PCT/EP02/06348

(30) Foreign Application Priority Data
Jun. 11, 2001 (DE) 101 28 204.4

(51) Int. Cl. C08L 61/00

(52) U.S. Cl. 525/507

(57) ABSTRACT

Cycloaliphatic compounds I which have side chains containing epoxide groups are prepared by heterogeneously catalyzed hydrogenation of a compound II which comprises at least one carbocyclic aromatic group and at least one side chain containing at least one epoxide group over a ruthenium catalyst, wherein the ruthenium catalyst is obtainable by

i) treating a support material based on amorphous silicon dioxide one or more times with a halogen-free aqueous solution of a low molecular weight ruthenium compound and subsequently drying the treated support material at below 200° C.,

ii) reducing the solid obtained in i) by means of hydrogen at from 100 to 350° C.,

where step ii) is carried out directly after step i).

The invention relates to a process for preparing cycloaliphatic compounds I which have side chains containing epoxide groups by heterogeneously catalyzed hydrogenation of a compound II which comprises at least one carbocyclic aromatic group and at least one side chain containing at least one epoxide group over a ruthenium catalyst.

The preparation of cycloaliphatic oxirane compounds I which contain no aromatic groups is of particular interest for the production of lightfast and weathering-resistant surface coating systems. Such compounds can basically be prepared by hydrogenation of aromatic compounds II having side chains containing oxirane groups, for example glycidyl groups. The compounds I are therefore also referred to as “ring-hydrogenated” oxirane compounds. The compounds II have long been known as constituents of surface coating systems (cf. J. W. Muskopf et al. “Epoxy Resins” in Ullmann's Encyclopedia of Industrial Chemistry, 5th Edition on CD-ROM).

However, the high reactivity of the oxirane groups is a problem in the catalytic hydrogenation. Under the reaction conditions usually required for hydrogenation of the aromatic ring, these groups are frequently reduced to alcohol. For this reason, the hydrogenation of the compounds II has to be carried out under very mild conditions. However, this naturally results in a slowing of the desired hydrogenation of the aromatic.

U.S. Pat. No. 3,336,241 teaches the hydrogenation of aromatic epoxy compounds using rhodium and ruthenium catalysts for preparing cycloaliphatic compounds containing epoxy groups. The activity of the catalysts decreases so greatly after one hydrogenation that in an industrial process the catalyst has to be replaced after each hydrogenation. In addition, the selectivity of the catalysts describe there leaves something to be desired.

DE-A 36 29 632 and DE-A 39 19 228 teach the selective hydrogenation of the aromatic parts of the molecules of bis(glycidyloxyphenyl)methane (bisphenol F) and 2,2-bis(p-glycidyloxyphenyl)propane (bisphenol A) over hydrated ruthenium oxide. This improves the selectivity of the hydrogenation in respect of the aromatic groups to be hydrogenated. However, these teachings also recommend regeneration of the catalyst after each hydrogenation. An additional problem in this regeneration is the difficulty of separating the catalyst from the reaction mixture.

EP-A 678512 teaches the selective hydrogenation of the aromatic parts of the molecules of aromatic compounds containing oxirane groups over ruthenium catalysts, preferably hydrated ruthenium oxide, in the presence of from 0.2 to 10% by weight of water, based on the reaction mixture. The presence of water makes the separation of the catalyst from the reaction mixture easier, however, the other disadvantages of these catalysts, such as short lifetime, are not overcome.

The processes of the prior art have the disadvantage that the catalysts used have only short operating lives and generally have to be regenerated at considerable cost after each hydrogenation. The activity of the catalysts also leaves something to be desired, so that only low space-time yields based on the catalyst used are obtained under the reaction conditions necessary for a selective hydrogenation. However, this is not economically feasible due to the high cost of ruthenium and thus of the catalyst.

It is an object of the present invention to provide a selective process for the hydrogenation of aromatic compounds II to give the “ring-hydrogenated” compounds I by means of which high space-time yields based on the catalyst used can be achieved and in which the catalysts used can be used a number of times for hydrogenations without work-up.

We have found that this object is achieved by use of ruthenium catalysts which are obtainable by:

i) treating a support material based on amorphous silicon dioxide one or more times with a halogen-free aqueous solution of a low molecular weight ruthenium compound and subsequently drying the treated support material at below 200° C., preferably at temperatures ≦180° C. and especially ≦150° C.,

ii) reducing the solid obtained in i) by means of hydrogen at from 100 to 350° C., preferably 150 to 350° C., and especially 200 to 350° C.,

where step ii) is carried out directly after step i).

The present invention accordingly provides a process for preparing cycloaliphatic compounds I which have side chains containing epoxide groups by heterogeneously catalyzed hydrogenation of a compound II which comprises at least one carbocyclic aromatic group and at least one side chain containing at least one epoxide group over a ruthenium catalyst as defined above.

The catalysts used in the process of the present invention display high activities and high selectivities in respect of the hydrogenation of the aromatic parts of the molecules of the compounds II. The activities are significantly above the activities achieved in the processes of the prior art at a comparable or improved selectivity. High space-time yields can thus be achieved under comparatively mild reaction conditions. In addition, the catalysts used in the process of the present invention have long operating lives.

It is presumed that the high activity of the catalysts used in the process of the present invention can be attributed to the particularly good distribution of the ruthenium over the surface of the support material and to the virtual absence of halogen in the support materials. As a result of the method of producing the catalysts used according to the present invention, the ruthenium is present in them as metallic ruthenium. Examination of the catalysts by transmission electron microscopy has shown that the ruthenium on the support material is present in atomically disperse form and/or in the form of ruthenium particles which are virtually exclusive, i.e. in a proportion of more than 90%, preferably more than 95%, based on the number of visible particles, present as isolated particles having diameters below 10 nm, in particular below 7 nm. In other words, the catalyst contains essentially no ruthenium particles and/or agglomerates of ruthenium particles having diameters above 10 nm, i.e. it contains a proportion of less than 10%, in particular less than 5%, of such particles and/or agglomerates. In addition, as a result of the use of halogen-free ruthenium precursors and solvents in the production of the catalysts used according to the present invention, the chlorine content of these catalysts is below 0.05% by weight (<500 ppm), based on the total weight of the catalyst. Here and in the following, all ppm-values are meant as parts by weight, unless indicated otherwise.

An important constituent of the catalysts used in the process of the present invention is the support material based on amorphous silicon dioxide. In this context, the term “amorphous” implies that the proportion of crystalline silicon dioxide phases in the support material is less than 10%. The support materials used for producing the catalysts can, however, have long-range structures formed by a regular arrangement of pores in the support material.

Suitable support materials are in principle all types of amorphous silicon dioxide which comprise at least 90% by weight of silicon dioxide, with the remaining 10% by weight, preferably not more than 5% by weight, of the support material being able to be made up of another oxidic material, e.g. MgO, CaO, TiO₂, ZrO₂, Fe₂O₃ or alkali metal oxide. It goes without saying that the support material used is likewise halogen-free, i.e. the halogen content is less than 500 ppm. The support material preferably contains no more than 1% by weight, in particular no more than 0.5% by weight and particularly preferably no detectable amounts (<500 ppm), of aluminum oxide, calculated as Al₂O₃. In a preferred embodiment, support materials containing less than 500 ppm of Fe₂O₃ are used. The alkali metal oxide content generally results from the preparation of the support material and can be up to 2% by weight. It is frequently less than 1% by weight. Supports which are free of alkali metal oxide (<0.1% by weight) are also suitable. The proportion of MgO, CaO, TiO₂ and ZrO₂ can be up to 10% by weight of the support material and is preferably no more than 5% by weight. However, support materials which contain no detectable amounts of these metal oxides (<0.1% by weight) are also suitable. In a preferred embodiment of the invention, the support material is halogen-free, i.e. the amount of halogen in the support material is less than 500 ppm.

Preference is given to support materials which have a specific surface area in the range from 30 to 700 m²/g, preferably from 30 to 300 m²/g (BET surface area in accordance with DIN 66131).

Suitable amorphous support materials based on silicon dioxide are well known to those skilled in the art and are commercially available (cf. for example, O. W. Flörke, “Silica” in Ullmann's Encyclopedia of Industrial Chemistry 5th ed. on CD-ROM). They can be either of natural origin or can have been produced synthetically. Examples of suitable amorphous support materials based on silicon dioxide are kieselguhr, silica gels, pyrogenic silica and precipitated silica. In a preferred embodiment of the invention, the catalysts comprise silica gels as support materials.

Depending on the way in which the process of the present invention is carried out, the support material can have differing shapes. If the process is carried out as a suspension process, the support material is usually used in the form of a finely divided powder for producing the catalysts used according to the present invention. The powder preferably has particle sizes in the range from 1 to 200 μm, in particular from 1 to 100 μm. When the catalyst is used in a fixed bed, it is usual to use shaped bodies of the support material which are obtainable by, for example, extrusion, ram extrusion or tableting and are, for example, in the form of spheres, pellets, cylinders, extrudates, rings or hollow cylinders, stars and the like. The dimensions of the shaped bodies are usually in the range from 1 mm to 25 mm. Use is frequently made of catalyst extrudates having extrudate diameters of from 2 to 5 mm and extrudate lengths of from 2 to 25 mm.

The ruthenium content of the catalysts can vary over a wide range. It is generally at least 0.1% by weight, preferably at least 0.2% by weight, and frequently does not exceed a value of 10% by weight, in each case based on the weight of the support material, and is calculated as elemental ruthenium. The ruthenium content is preferably in the range from 0.2 to 7% by weight, in particular in the range from 0.4 to 5% by weight.

The ruthenium catalysts used in the process of the present invention are generally produced by firstly treating the support material with a halogen-free aqueous solution of a low molecular weight ruthenium compound, hereinafter referred to as (ruthenium) precursor, in such a way that the desired amount of ruthenium is taken up by the support material. This step will hereinafter also be referred to as impregnation. The support which has been treated in this way is subsequently dried complying with the abovementioned upper temperature limits. The solid obtained in this way may, if necessary, then be treated again with the aqueous solution of the ruthenium precursor and dried again. This procedure is repeated until the amount of ruthenium compound taken up by the support material corresponds to the desired ruthenium content of the catalyst.

The treatment or impregnation of the support material can be carried out in various ways and depends, as is known, on the physical form of the support material. For example, the support material can be sprayed with the precursor solution, the precursor solution can be passed over it or the support material can be suspended in the precursor solution. For example, the support material can be suspended in the aqueous solution of the ruthenium precursor and filtered from the aqueous liquid after a certain time. The ruthenium content of the catalyst can then be controlled in a simple manner via the amount of liquid taken up and the ruthenium concentration of the solution. Impregnation of the support material can also be carried out by, for example, treating the support with a defined amount of the aqueous solution of the ruthenium precursor which corresponds to the maximum amount of liquid which can be taken up by the support material. For this purpose, the support material can, for example, be sprayed with the appropriate amount of the liquid.

Suitable apparatuses for this purpose are the apparatuses customarily used for mixing liquids with solids (cf. Vauck/Müller, Grundoperationen chemischer Verfahrenstechnik, 10th Edition, Deutscher Verlag für Grundstoffindustrie, 1994, p. 405 ff.), for example tumble dryers, impregnation drums, drum mixers, blade mixers and the like. In the case of monolithic supports, the aqueous solutions of the ruthenium precursor are usually passed over the support.

The aqueous solutions used for impregnation are preferably halogen-free, i.e. they contain no halogen or less than 500 ppm, especially less than 100 ppm of halogen, based upon the total weight of the solution. For this reason, the ruthenium precursors used are preferably ruthenium compounds which contain no chemically bound halogen and are sufficiently soluble in the aqueous solvent. These include, for example, ruthenium(III) nitrosyl nitrate (Ru(NO)(NO₃)₃), ruthenium(III) acetate and alkali metal ruthenates(IV) such as sodium or potassium ruthenate(IV). However, halogen-containing ruthenium compounds, such as RuCl₃ or mixtures therof with halogen-free ruthenium precursors, may also be used in prinicple.

In the present context, the term “aqueous” refers to water and mixtures of water with up to 50% by volume, preferably no more than 30% by volume and in particular no more than 10% by volume, of one or more water-miscible organic solvents, e.g. mixtures of water with C₁-C₄-alkanols such as methanol, ethanol, n-propanol or isopropanol. Water is frequently used as sole solvent. The aqueous solvent will frequently further comprise at least one halogen-free acid, e.g. nitric acid, sulfuric acid, phosphoric acid or acetic acid, preferably a halogen-free mineral acid, for stabilizing the ruthenium precursor in the solution. In many cases, a halogen-free mineral acid diluted with water, e.g. diluted to half-concentrated nitric acid, is therefore used as solvent for the ruthenium precursor. The concentration of the ruthenium precursor in the aqueous solutions naturally depends on the amount of ruthenium precursor to be applied and on the uptake capacity of the support material for the aqueous solution and is generally in the range from 0.1 to 20% by weight.

Drying can be carried out complying with the abovementioned upper temperature limits using customary methods of solids drying. Adherence to the upper limit prescribed according to the present invention for the drying temperatures is important for the quality, i.e. the activity, of the catalyst. Exceeding the abovementioned drying temperatures leads to a significant loss of activity. Calcination of the support at higher temperatures, e.g. above 300° C. or even 400° C., as is proposed in the prior art, is not only superfluous but also has an adverse effect on the activity of the catalyst. In order to obtain a sufficient drying rate, the drying is usually performed ar elevated temperatures, e.g. at least 40° C., preferably at least 70° C., and especially at least 100° C.

Drying of the solid which has been impregnated with the ruthenium precursor is usually carried out under atmospheric pressure, but it is also possible to employ subatmospheric pressure to promote drying. A gas stream, e.g. air or nitrogen, is frequently passed over or through the material to be dried in order to promote drying.

The drying time naturally depends on the degree of drying desired and on the drying temperature and is generally in the range from 2 hours to 30 hours, preferably in the range from 4 to 15 hours.

The treated support material is preferably dried to such an extent that the content of water or of volatile solvent constituents is less than 5% by weight, in particular no more than 2% by weight and particularly preferably no more than 1% by weight, based on the total weight of the solid, prior to the reduction ii). The proportions by weight indicated here are based on the weight loss experienced by the solid at 300° C. and a pressure of 1 bar over a time of 10 minutes. The activity of the catalysts used according to the present invention can be increased further in this way.

The solid treated with the precursor solution is preferably kept in motion during drying, for example by drying the solid in a rotary tube oven or a rotary sphere oven. The activity of the catalysts used according to the present invention can be increased further in this way.

The conversion of the solid obtained after drying into its catalytically active form is, according to the present invention, carried out by hydrogenation of the solid in a manner known per se at the abovementioned temperatures (step ii).

For this purpose, the support material is brought into contact with hydrogen or a mixture of hydrogen and an inert gas at the abovementioned temperatures. The hydrogen partial pressure is of minor importance for the result of the reduction and can vary in the range from 0.2 bar to 1.5 bar. The hydrogenation of the catalyst material is usually carried out in a stream of hydrogen at atmospheric pressure. The solid obtained in i) is preferably kept in motion during the hydrogenation, for example by carrying out the hydrogenation of the solid in a rotary tube oven or a rotary sphere oven. The activity of the catalysts used according to the present invention can be increased further in this way.

Subsequent to the hydrogenation, the catalyst can be passivated in a known manner to improve handling, e.g. by briefly treating the catalyst with an oxygen-containing gas, e.g. air but preferably an inert gas mixture containing from 1 to 10% by volume of oxygen.

Suitable starting compounds II are all organic molecules which comprise at least one carbocyclic aromatic group, preferably at least one benzene ring, and at least one side chain containing an oxirane group. The side chains are generally epoxidized C₃-C₁₀-alkenyl groups, e.g. glycidyl groups (2,3-oxypropen-1-yl groups), which are bound directly or via a heteroatom, e.g. via oxygen or nitrogen, or via a carboxyl or carboxamide group to the aromatic. The compounds II can of course comprise one or more aromatic groups which are linked to one another via oxygen or nitrogen atoms or via alkylene or cycloalkylene groups. In the compounds II, it is of course possible for each of the aromatic groups or only some of the aromatic groups to bear side chains containing oxirane groups.

The compounds II can be monomeric, oligomeric or polymeric compounds.

Examples of suitable starting compounds for the process of the present invention include the following classes of substances and materials:

Products of the reaction of bisphenol A or bisphenol F or comparable alkylene- or cycloalkylene-bridged bisphenol compounds with epichlorohydrin.

Bisphenol A or bisphenol F or comparable compounds can be reacted with epichlorohydrin and bases in a known manner (e.g. Ullmann's Encyclopedia of Industrial Chemistry, 5th Edition, VCH (1987) Vol. A9, p. 547) to form glycidyl ethers of the formula IIa

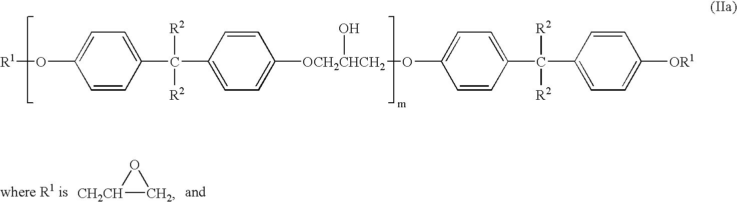

R² is hydrogen or a C₁-C₄-alkyl group, e.g. methyl, or two radicals R² bound to a single carbon atom form a C₃-C₅-alkylene group and m is from 0 to 40.

Phenol and cresol epoxy novolaks IIb

Novolaks of the formula IIb are obtainable by acid-catalyzed reaction of phenol or cresol and conversion of the reaction products into the corresponding glycidyl ethers (e.g. bis[4-(2,3-epoxypropoxy)phenyl]methane):

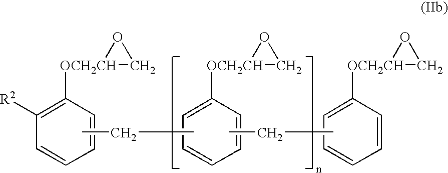

where R² is hydrogen or a methyl group and n is from 0 to 40 (cf. J. W. Muskopf et al. “Epoxy Resins 2.2.2” in Ullmann's Encyclopedia of Industrial Chemistry, 5th Edition on CD-ROM).

Glycidyl ethers of reaction products of phenol and an aldehyde:

Glycidyl ethers are obtainable by acid-catalyzed reaction of phenol and aldehydes and subsequent reaction with epichlorohydrin, e.g. 1,1,2,2-tetrakis[4-(2,3-epoxypropoxy)phenyl]ethane can be obtained from phenol and glyoxal (cf. J. W. Muskopf et al. “Epoxy Resins 2.2.3” in Ullmann's Encyclopedia of Industrial Chemistry, 5th Edition on CD-ROM).

Glycidyl ethers of phenol-hydrocarbon novolaks, e.g. 2,5-bis[(glycidyloxy)phenyl]octahydro-4,7-methano-5H-indene and its oligomers.

Aromatic glycidylamines:

Examples are the triglycidyl compound of p-aminophenol, viz. 1-(glycidyloxy)-4-[N,N-bis(glycidyl)amino]benzene, and the tetraglycidyl compound of methylenediamine, bis{4-[N,N-bis(2,3-epoxypropyl)amino]phenyl}methane.

Further specific examples of compounds II are: tris[4-(glycidyloxy)phenyl]methane isomers. Mention may also be made of:

glycidyl esters of aromatic monocarboxylic, dicarboxylic and tricarboxylic acids, e.g. diglycidyl phthalate and diglycidyl isophthalate.

Preference is given to compounds II having glycidyl side chains, in particular glycidyl ethers and their oligomers which still contain glycidyl groups.

Particularly preferred starting compounds are di[p-glycidoxyphenyl]methane and 2,2-di[p-glycidoxyphenyl]propane and oligomers of these compounds which still contain glycidyl groups.

In the process of the present invention, the hydrogenation of the compounds II is generally carried out in the liquid phase. Owing to the sometimes high viscosity of the compounds II, they are preferably used as a solution or mixture in an organic solvent. Suitable organic solvents are in principle all those which can dissolve the compound II virtually completely or are completely miscible therewith and which are inert under the hydrogenation conditions, i.e. are not hydrogenated. Examples of suitable solvents are cyclic and alicyclic ethers, e.g. tetrahydrofuran, dioxane, methyl tert-butyl ether, dimethoxyethane, dimethoxypropane or diethylene glycol dimethyl ether, aliphatic alcohols such as methanol, ethanol, n-propanol or isopropanol, n-butanol, 2-butanol, isobutanol or tert-butanol and also aliphatic ether alcohols such as methoxypropanol. The concentration of compound II in the liquid phase to be hydrogenated can in principle be chosen freely and is frequently in the range from 20 to 95% by weight, based on the total weight of the solution/mixture. In the case of compounds II which are sufficiently fluid under the reaction conditions, the hydrogenation can also be carried out in the absence of a solvent.

In a number of cases, it has been found to be advantageous to carry out the reaction in the presence of water. The proportion of water can be, based on the mixture to be hydrogenated, up to 10% by weight, e.g. from 0.1 to 10% by weight, preferably from 0.2 to 7% by weight and in particular from 0.5 to 5% by weight.

The actual hydrogenation is usually carried out by a method analogous to known hydrogenation processes for the preparation of compounds I, as are described in the prior art cited at the outset. For this purpose, the compound II, preferably as a liquid phase, is brought into contact with the catalyst in the presence of hydrogen. The catalyst can either be suspended in the liquid phase (suspension process) or the liquid phase is passed over a fluidized catalyst bed (fluidized-bed process) or a fixed catalyst bed (fixed-bed process). The hydrogenation can be carried out either continuously or batchwise. The process of the present invention is preferably carried out in fixed-bed reactors operated in the downflow mode. The hydrogen can be passed over the catalyst either in concurrent with the solution of the starting material to be hydrogenated or in countercurrent.

Suitable apparatuses for carrying out a hydrogenation by the suspension method and for hydrogenations over a fluidized catalyst bed or a fixed catalyst bed are known from the prior art, e.g. from Ullmanns Enzyklopädie der Technischen Chemie, 4th Edition, Volume 13, p. 135 ff., and from P. N. Rylander, “Hydrogenation and Dehydrogenation” in Ullmann's Encyclopedia of Industrial Chemistry, 5th ed. on CD-ROM.

The hydrogenation can be carried out either under hydrogen at atmospheric pressure or at a superatmospheric hydrogen pressure, e.g. at a hydrogen partial pressure of at least 1.1 bar, preferably at least 10 bar. In general, the hydrogen partial pressure will not exceed a value of 325 bar and preferably 300 bar. The hydrogen partial pressure is particularly preferably in the range from 50 to 300 bar. The reaction temperatures are generally at least 30° C. and will frequently not exceed a value of 150° C. In particular, the hydrogenation process is carried out at from 40 to 100° C., particularly preferably from 50 to 80° C.

Suitable reaction gases include not only hydrogen but also hydrogen-containing gases which contain no catalyst poisons such as carbon monoxide or sulfur-containing gases, e.g. mixtures of hydrogen with inert gases such as nitrogen or offgases from a reformer which usually further comprise volatile hydrocarbons. Preference is given to using pure hydrogen (purity>99.99% by volume).

Owing to the high catalyst activity, relatively small amounts of catalyst based on the starting material used are required. Thus, less than 5 mol %, e.g. from 0.2 mol % to 2 mol %, of ruthenium are generally used per 1 mol of compound II in a batchwise suspension process. In the case of a continuous hydrogenation process, the starting material II to be hydrogenated is usually passed over the catalyst in an amount of from 0.05 to 3 kg/(l(catalyst)*h), in particular from 0.2 to 2 kg/(l(catalyst)*h).

Of course, the catalysts used in this process can be regenerated by the known methods customary for noble metal catalysts such as ruthenium catalysts when their activity drops. This can be achieved, for example, by treatment of the catalyst with oxygen as described in BE 882279, treatment with dilute, halogen-free mineral acids as described in U.S. Pat. No. 4,072,628 or treatment with hydrogen peroxide, e.g. in the form of aqueous solutions having a concentration of from 0.1 to 35% by weight, or treatment with other oxidizing substances, preferably in the form of halogen-free solutions. After reactivation and before reuse, the catalyst is usually rinsed with a solvent, e.g. water.

The following examples serve to illustrate the invention:

The conversion was determined by means of ¹H-NMR (decrease in the signals of the aromatic protons and increase in those of the aliphatic protons). The conversion reported in the examples is based on the hydrogenation of the aromatic groups.

The determination of the decrease in the epoxide groups was carried out by comparison of the epoxide equivalent before and after the hydrogenation, in each case determined in accordance with ASTM-D-1652-88.

I Production of the Catalysts

1. Production of Catalysts A and B According to the Present Invention (General Method).

A defined amount of support material in a dish was impregnated with the maximum amount of a solution of ruthenium(III) nitrosyl nitrate in water which could be taken up by the respective support material. The maximum amount of liquid able to be taken up by the respective support material was determined beforehand on an authentic sample. The concentration of the solution was calculated so that the desired concentration of ruthenium in the support material resulted.

The solid obtained in this way was subsequently dried at 120° C. for 13 hours in a rotary sphere oven and had a residual water content of <1% by weight (determined as weight loss of a test sample dreid for 10 min at 300° C. and 1 bar). The solid obtained in this way was reduced at 300° C. in a stream of hydrogen under atmospheric pressure for 4 hours in a reaction tube. After cooling and blanketing with nitrogen, the catalyst was passivated by passing 5% by volume of air in nitrogen over it for a period of 120 minutes.

Catalyst A: Support material: silica gel powder having an SiO₂ content of >99.5% by weight and a specific BET surface area of 68 m²/g, a water uptake of 1.12 ml/g and a particle size <100 μm. Ruthenium content of catalyst A: 4.6% by weight.

Catalyst B: Silica gel extrudates (d=4 mm, l=1-10 mm) having an SiO₂ content of >99.5% by weight (0.3% by weight of Na₂O), a specific BET surface area of 169 m²/g, a water uptake of 0.95 ml/g and a pore volume of 0.7 ml/g (DIN 66134). Ruthenium content of catalyst B: 4.7% by weight

2. Comparative Catalyst (Hydrated Ruthenium Oxide)

Hydrated ruthenium oxide was obtained as a moist precipitate by reaction of an aqueous solution of ruthenium(III) chloride hydrate, RuCl₃×3H₂O, with aqueous sodium hydroxide at pH 8 and subsequent washing with water and THF.

II. Hydrogenation of Bisphenol F Glycidyl Ether in the Batch Mode (Examples 1 and 2 and Comparative Example) and Continuous Upflow Mode (Example 3)

### EXAMPLE 1

### Batchwise Hydrogenation Using Catalyst A

150 ml of a 50% strength by weight solution of bisphenol F glycidyl ether in tetrahydrofuran together with 5 g of catalyst A and about 3 g of water were placed in a 300 ml autoclave fitted with a stirrer. The autoclave was subsequently pressurized with 150 to 250 bar of pure hydrogen and was heated to 70-80° C. During the reaction, the reaction mixture was stirred at 800 rpm. After absorption of hydrogen had ceased, the autoclave was vented. The catalyst was allowed to settle, the supernatant solution was taken off via a riser tube and was replaced by 100 ml of fresh solution of the starting material. 24 subsequent hydrogenations were carried out analogously. The product mixture after the reaction was examined by means of ¹H-NMR. The conversion, based on aromatic groups, was more than 99% in all reactions, with the proportion of hydrogenated epoxide groups always being 4%. 0.02% of Ru was required per kg of glycidyl ether.

### COMPARATIVE EXAMPLE

### Batchwise Hydrogenation Over Hydrated Ruthenium Oxide

2400 ml of a 50% strength solution of bisphenol F glycidyl ether in tetrahydrofuran (THF), 96 ml of a suspension of hydrated ruthenium oxide in tetrahydrofuran having a ruthenium content of 25 g/l, prepared as described in 1.2, and 48 g of water were placed in a 3500 ml autoclave fitted with a stirrer at 60-70° C. The autoclave was subsequently pressurized with 150 to 250 bar of pure hydrogen and was heated to 70-80° C. During the reaction, the reaction mixture was stirred at 800 rpm. After absorption of hydrogen had ceased, the autoclave was vented. The catalyst was allowed to settle, the supernatant solution was taken off via a riser tube and was replaced by 2000 ml of fresh solution of the starting material. 2 subsequent hydrogenations were carried out analogously. The product mixture after the reaction was examined by means of ¹H-NMR.

The residual content of aromatic groups after the first hydrogenation was 2.3%, after the second hydrogenation 18.1% and after the third hydrogenation 27%. The proportion of hydrogenated epoxide groups in the first run was less than 5%. 2 g of Ru were required per kg of diglycidyl ether.

### EXAMPLE 2

### Batchwise Hydrogenation Using Catalyst B

150 ml of a 50% strength by weight solution of bisphenol F glycidyl ether in tetrahydrofuran, 7 g of catalyst B (Ru/SiO₂ extrudates in a basket insert) and about 6 g of water were placed in a 300 ml autoclave fitted with a stirrer. The autoclave was subsequently pressurized with 150 to 250 bar of hydrogen and was heated to 70-80° C. During the reaction, the reaction mixture was stirred at 1000 rpm. After absorption of hydrogen had ceased, the autoclave was vented. The catalyst was allowed to settle, the supernatant solution was taken off via a riser tube and was replaced by 100 ml of fresh solution of the starting material. 12 subsequent hydrogenations were carried out analogously. The conversion was always better than 99%, with the proportion of hydrogenated epoxide groups being 10% in all hydrations. 0.05% of Ru was required per kg of glycidyl ether.

### EXAMPLE 3

### Continuous Hydrogenation Over a Catalyst bed

The apparatus employed comprised an electrically heated stainless steel reaction tube charged with 75 g of catalyst B (160 ml), a feed pump for the starting material, sampling facilities and a separator with level regulation and provided with an offgas regulator. The reaction mixture was passed through the reaction tube from the bottom upward.

In the reaction apparatus, 52 g/h of a 40% strength by weight solution of bisphenol F glycidyl ether in tetrahydrofuran, which contained 2% by weight of water, was hydrogenated at 50-80° C. and a hydrogen pressure of 130 bar.

At a weight hourly space velocity over the catalyst of 0.28 kg/l·h based on catalyst, the conversion was more than 99.9% and the proportion of hydrogenated epoxide groups was less than 5%.

The results of Examples 1 to 3 and the comparative example are summarized in Table 1:

TABLE 1

| | | | | Proportion | |
|---|---|---|---|---|---|
| | | | | of | Proportion |
| | | | Con- | hydrogenated | of residual |
| | | | ver- | epoxide | aromatic |
| | | Number of | sion | groups | groups |
| Example | Catalyst | passes | [%] | [%] | [%] |
| 1 | A | 25 | >99 | <4 | <1 |
| Ca | Hydrated | 1 | 97.7 | <5 | 2.3 |
| | ruthenium | | | | |
| | oxide | | | | |
| Cb | Hydrated | 2 | 81.9 | n.d. | 18.1 |
| | ruthenium | | | | |
| | oxide | | | | |
| Cc | Hydrated | 3 | 73 | n.d. | 27 |
| | ruthenium | | | | |
| | oxide | | | | |
| 2 | B | 13 | >99 | <10 | <1 |
| 3 | B | Continuous | >99.9 | <5 | <1 |

We claim:

1. A process for preparing cycloaliphatic compounds I which have side chains containing epoxide groups by heterogeneously catalyzed hydrogenation of a compound II which comprises at least one carbocyclic aromatic group and at least one side chain containing at least one epoxide group over a ruthenium catalyst,
wherein the ruthenium catalyst is obtainable by
i) treating a support material based on amorphous silicon dioxide, wherein the support material consists of at least 90% by weight of silicon dioxide, based upon the total weight of the support material, and contains up to 10% by weight of crystalline silicon dioxide phases, based upon the total weight of the support material, one or more times with a halogen-free aqueous solution of a low molecular weight ruthenium compound and subsequently drying the treated support material at below 200° C.,
ii) reducing the solid obtained in i) by means of hydrogen at from 100 to 350° C.,
where step ii) is carried out directly after step i).

2. A process as claimed in claim 1, wherein the support based on amorphous silicon dioxide has a BET surface area in the range from 30 to 700 m²/g.

3. A process as claimed in either of the preceding claims, wherein the ruthenium catalyst contains from 0.2 to 10% by weight of ruthenium, based on the weight of the support.

4. A process as claimed in claim 1, wherein the ruthenium catalyst contains less than 0.05% by weight of halogen, based on the total weight of the catalyst, and comprises:
a support material based on amorphous silicon dioxide and
elemental ruthenium which is present in atomically disperse form and/or in the form of ruthenium particles on the support,
where the catalyst contains essentially no ruthenium particles and/or agglomerates having diameters above 10 nm.

5. A process as claimed in any of the preceding claims, wherein the compound II is used as a solution in an organic solvent which is inert under the hydrogenation conditions, where the solution contains from 0.1 to 10% by weight of water, based on the solvent.

6. A process as claimed in any of the preceding claims, wherein the compound II is selected from among aromatic glycidyl ethers and their oligomers which still contain glycidyl groups.

7. A process as claimed in claim 6, wherein the compound II is selected from among bis(4-glycidyloxyphenyl)methane and 2,2-bis(4-glycidyloxyphenyl)propane and their oligomers which still contain glycidyl groups.

8. A process as claimed in any of claims 1 to 5, wherein the compound II is selected from among aromatic N-glycidylamines and their oligomers which still contain glycidyl groups.

9. A process as claimed in any of the preceding claims, wherein the hydrogenation is carried out at a hydrogen partial pressure in the range from 10 to 300 bar.

10. A process as claimed in any of the preceding claims, wherein the hydrogenation is carried out at from 30 to 150° C.

11. A process as claimed in any of the preceding claims, wherein the hydrogenation is carried out over a fixed catalyst bed.

12. A process as claimed in any of the preceding claims, wherein the hydrogenation is carried out in a liquid phase in which the catalyst is present in the form of a suspension.
